(19) United States
(12) Patent Application Publication
(10) Pub. No.: US 2026/0253512 A1
(43) Pub. Date: Aug. 27, 2026

(54) METHOD, APPARATUS, AND PROGRAM FOR ASSISTING CONVERSATION

(71) Applicant: RISO KAGAKU CORPORATION, Tokyo (JP)

(72) Inventors: Akiko NOZAWA, Tokyo (JP); Akira HASHIMOTO, Tokyo (JP); Masato OKUMOTO, Tokyo (JP); Arocha MAHAPANNAPORN, Tokyo (JP); Ryuji MURABAYASHI, Tokyo (JP); Takahiko NAKAMURA, Tokyo (JP)

(73) Assignee: RISO KAGAKU CORPORATION, Tokyo (JP)

(21) Appl. No.: 19/542,937

(22) Filed: Feb. 18, 2026

(30) Foreign Application Priority Data
Feb. 26, 2025 (JP) 2025-029325
Mar. 18, 2025 (JP) 2025-043223
Mar. 18, 2025 (JP) 2025-043340

(51) Int. Cl. G09B 21/04; G06F 16/34; G10L 13/08; G10L 15/26

(52) U.S. Cl. CPC G09B 21/04; G06F 16/345; G10L 13/08; G10L 15/26

(57) ABSTRACT

A conversation assisting apparatus includes: a first text data receiving unit that receives first text data converted from audio data of speech by a hearing individual; a second text data receiving unit that receives a video of sign language gestures performed by a hearing impaired individual; a time information obtaining unit that obtains time information that indicates a start time of reception of the audio data and reception of the sign language video; and a control unit that displays the text data of the hearing individual arranged in chronological order based on the time information, and in the case that sign language gestures or text data input by the hearing impaired individual begins during speech by the hearing individual, inserts and displays text data which is translated from the sign language video by the hearing impaired individual into the text data of the speech.

### CROSS-REFERENCE TO RELATED APPLICATIONS

The present application claims priority under 35 U.S.C. §119 to Japanese Patent Application No. 2025-29325, filed on Feb. 26, 2025, Japanese Patent Application No. 2025-43223, filed on Mar. 18, 2025 and Japanese Patent Application No. 2025-43340, filed on Mar. 18, 2025. The above applications are hereby expressly incorporated by reference, in these entireties, into the present application.

### BACKGROUND OF THE INVENTION

### 1. Field of the Invention

The present disclosure relates to an apparatus, a method, and a program for assisting conversation between hearing impaired individuals and hearing individuals.

### 2. Description of the Related Art

Conventionally, both hearing individuals (those with normal hearing) and hearing impaired individuals (those with hearing impairments) may participate in situations such as meetings. In such meetings, when hearing and hearing impaired individuals communicate, text has been employed as a common language.

Specifically, for speech by the hearing individual, audio data is obtained via a microphone and converted to text for display. For communication by the hearing impaired individual, text is displayed either by inputting text employing a personal computer of the hearing impaired individual, or by capturing sign language gestures performed by the hearing impaired individual and translating the captured sign language video into text data. This enables the hearing and hearing impaired individuals to converse by viewing the displayed text.

Japanese Unexamined Patent Publication No. 2024-74245 proposes a method for acquiring audio data from individuals of a conversation, graphically displaying their speech activity in chronological order, and outputting audio data for selected portions.

Japanese Unexamined Patent Publication No. 2017-204067 proposes a method for translating sign language videos of hearing impaired individuals captured by a camera into text or speech, which is output employing a computer.

Japanese Unexamined Patent Publication No. 2021-157139 proposes a method for pinning the text display of a specified statement, asking questions, and obtaining answers when displaying audio data of statements made during a meeting as text in a format in chronological order.

### SUMMARY OF THE INVENTION

Here, for example, when conducting a meeting where a hearing impaired individual participates with two or more hearing individuals, as described above, statements by the hearing individuals are displayed as text by converting audio data to text, while statements by the hearing impaired individual are displayed as text through sign language translation or text input. However, there may be cases in which discussions proceed by verbal communication among the hearing individuals.

In such a situation, when a hearing impaired individual speaks via sign language gestures or text input, time is required to complete translation of the sign language after the gestures end or for the hearing impaired individual to finish the input of text. During this time, discussion by the hearing individuals may proceed to a new topic, causing the statement by the hearing impaired individual to be displayed as text later than the actual timing at which they wished to communicate.

As a result, an issue arises where it becomes unclear what topic the statement by the hearing impaired individual pertains to.

Patent Documents 1 through 3 do not address the timing discrepancy in displaying text that represents statements by a hearing impaired individual described above. While Patent Document 3 proposes a method for pinning topics to be discussed in a meeting in order to conduct conversations while the topic is being displayed, it does not take the two way conversation between a hearing impaired individual and hearing individuals described above into consideration.

The present disclosure has been developed in view of the foregoing circumstances. The present disclosure provides a method, an apparatus, and a program for assisting conversation that enables confirmation of connections in conversations between hearing impaired individuals and hearing individuals, facilitates smooth communication, and enables conversations to proceed appropriately.

A conversation assisting apparatus of the present disclosure assists conversation between a first individual in a conversation who converses employing audible speech and a second individual in the conversation who converses without employing audible speech, and is equipped with: a first text data receiving unit that receives first text data converted from audio data of speech by the first individual; a second text data receiving unit that receives second text data, which is one of text data converted from images capturing sign language gestures performed by the second individual and text data input by the second individual; a time information obtaining unit that obtains time information that indicates a start time of the conversation initiated by speech by one of the first individual and sign language gestures or text data input by the second individual; and a control unit that displays the first text data of the first individual’s speech in chronological order in predetermined speech segments according to the time information obtained by the time information obtaining unit, and in the case that the second individual in sign language gestures or text data input begins during speech by the first individual, inserts and displays the second text data into the first text data of the speech by the first individual in chronological order after the receiving of second text data of the second individual has been completed.

According to the conversation assisting apparatus of the present disclosure, the text data that represents speech by the hearing individual is displayed in chronological order based on predetermined speech segments. In the case that a sign language video or text data input by the hearing impaired individual is received during the speech by the hearing individual, the translated text data of the hearing impaired individual’s sign language video or the text data input by the hearing impaired individual is inserted into the text data that represents speech by the hearing individual and displayed in chronological order after the receiving of the hearing impaired individual’s sign language video or input text data is completed. This enables connections within the conversation between the hearing impaired individual and the hearing individuals to be confirmed, facilitates smooth communication, and enables the conversation to proceed appropriately.

### BRIEF DESCRIPTION OF THE DRAWINGS

FIG. 1 is a block diagram that illustrates the schematic configuration of a meeting assisting system that employs a first embodiment of the conversation assisting apparatus of the present disclosure.

FIG. 2 is a flowchart for explaining the flow of processes performed by the meeting assisting system illustrated in FIG. 1.

FIG. 3 is a diagram that illustrates an example of a meeting screen displayed on a terminal device for a hearing impaired individual.

FIG. 4 is a diagram that illustrates an example of a meeting screen displayed on a shared terminal device.

FIG. 5 is a diagram that illustrates an example of the main conversation screen within a text display frame.

FIG. 6 is a diagram that illustrates an example of a “Statement was Made” display.

FIG. 7 is a diagram that illustrates an example of a pop up display.

FIG. 8 is a diagram that illustrates an example of a sub conversation screen.

FIG. 9 is a diagram that illustrates an example of the main conversation screen after returning from the sub conversation screen.

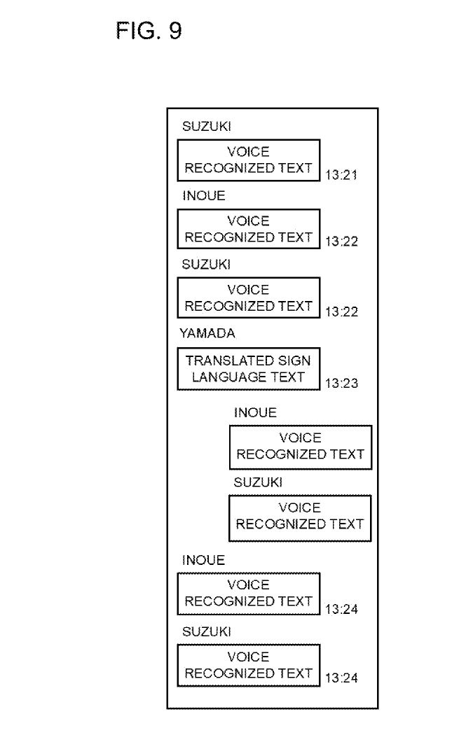

FIG. 10 is a block diagram that illustrates the schematic configuration of a meeting assisting system that employs a second embodiment of the conversation assisting apparatus of the present disclosure.

FIG. 11 is a flowchart for explaining the flow of processes performed by the meeting assisting system illustrated in FIG. 10.

FIG. 12 is a diagram that illustrates examples of displays within a text display frame of a terminal device for a hearing impaired individual and a text display frame of a shared terminal device.

FIG. 13 is a diagram that illustrates an example of a speech-to-text conversion option screen.

FIG. 14 is a block diagram that illustrates the schematic configuration of a meeting assisting system that employs a third embodiment of the conversation assisting apparatus of the present disclosure.

FIG. 15 is a flowchart for explaining the flow of processes performed by meeting assisting system illustrated in FIG. 14.

FIG. 16 is a flowchart for explaining the flow of processes performed by meeting assisting system illustrated in FIG. 14.

FIG. 17 is a diagram that illustrates examples of displays within a text display frame of a terminal device for a hearing impaired individual and a text display frame of a shared terminal device.

FIG. 18 is a diagram that illustrates an example of display in which text data that summarizes statements by a hearing individual is associated with second text data input by a hearing impaired individual.

### DETAILED DESCRIPTION OF THE EMBODIMENTS

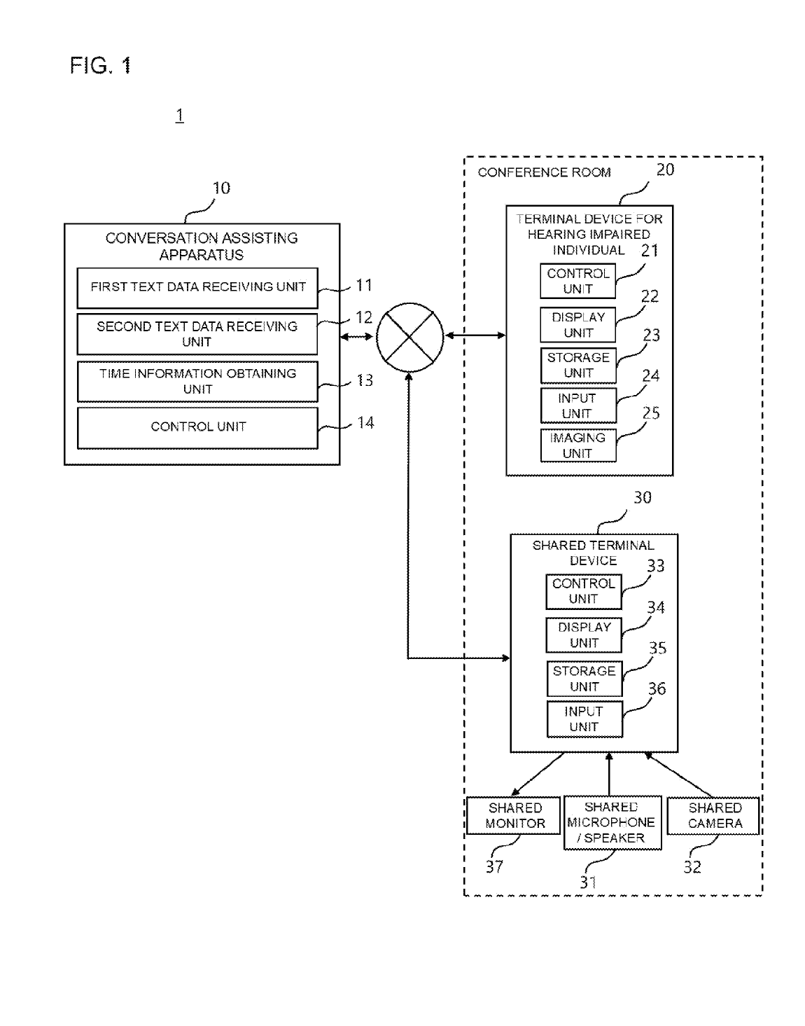

A meeting assisting system 1 that employs a first embodiment of conversation assisting apparatus of the present disclosure will be described in detail below, with reference to the attached drawings. FIG. 1 is a block diagram that illustrates the schematic configuration of a meeting assisting system 1 of the present embodiment.

The meeting assisting system 1 of the present embodiment is a system that assists conversation for hearing impaired individuals in meetings by displaying the conversation between hearing individuals and hearing impaired individuals as text. The present embodiment will be described as a system that assists conversation in a meeting involving two hearing individuals and one hearing impaired individual. However, the number of hearing and hearing impaired individuals in the conversation is not limited to two and one, respectively, and may be increased.

As illustrated in FIG. 1, the meeting assisting system 1 of the present embodiment is equipped with a conversation assisting apparatus 10, a terminal device 20 for a hearing impaired individual, and a shared terminal device 30. The conversation assisting apparatus 10 is a cloud server, while the terminal device 20 for the hearing impaired individual and the shared terminal device 30 are installed in a conference room used by the hearing individuals and the hearing impaired individual. Note that in the present embodiment, the conversation assisting apparatus 10 is implemented by employing a cloud server. However, the present disclosure is not limited to such a configuration, and the conversation assisting apparatus may also be implemented employing an internal local server, or the functions of the conversation assisting apparatus 10 may be implemented within the shared terminal device 30 of the present embodiment such that the shared terminal device 30 performs the functions of both elements.

The conversation assisting apparatus 10, the terminal device 20 for the hearing impaired individual, and the shared terminal device 30 are connected via communication lines such as the Internet or a LAN (Local Area Network), and are configured to enable the exchange of various types of data among them. Note that FIG. 1 illustrates only one terminal device 20 for the hearing impaired individual. However, but in practice, it is preferable to provide a terminal device for each hearing impaired individual of the conversation. In addition, in the present embodiment, two hearing individuals employ one shared terminal device 30, but it is also possible for each hearing individual to use their own terminal device.

Each of the elements that constitute the meeting assisting system 1 will be described in greater detail below.

As illustrated in FIG. 1, the conversation assisting apparatus 10 comprises a first text data receiving unit 11, a second text data receiving unit 12, a time information obtaining unit 13, and a control unit 14.

The first text data receiving unit 11 receives audio data of the conversation by hearing individuals, which is output from a shared microphone/speaker 31 connected to the shared terminal device 30, and converts the audio data into text data (hereinafter referred to as the first text data). Known speech recognition technologies that employ machine learning, such as recurrent neural networks (RNN), convolutional neural networks (CNN), and transformer models, may be employed to convert the audio data to the text data.

The second text data receiving unit 12 receives input of sign language video, which is captured employing a camera function of the terminal device 20 for the hearing impaired individual. The second text data receiving unit 12 translates the input sign language video, converts it into text data, then receives the text data as second text data. As a method for translating sign language video into text data, for example, one method that prepares a trained model which has been pretrained employing machine learning on the relationship between various sign language videos and their corresponding text data, inputs the sign language video received by the second text data receiving unit 12 into the trained model, and then converts it into text data may be employed.

In addition, the second text data receiving unit 12 is also capable of receiving input text data which is input by a hearing impaired individual on the terminal device 20 for the hearing impaired individual as the second text data. The terminal device 20 for the hearing impaired individual of the present embodiment is configured to enable both sign language video capture and text input, enabling the hearing impaired individual to participate in the conversation by inputting either sign language or text.

The time information obtaining unit 13 obtains time information of the start of the conversation, based on the speech by the hearing individual and the sign language gestures or text data input by the hearing impaired individual. In the present embodiment, the time information obtaining unit 13 obtains the time information of the start of the speech by the hearing individual as the time information of the initiation time for receiving audio data by the first text data receiving unit 11. In addition, the time information obtaining unit 13 obtains the time information of the start of the communication by the hearing impaired individual as the time information of the initiation of reception of sign language video and input text data by the second text data receiving unit 12.

The start time for receiving audio data is defined as the point at which audio data is received when audio data has not been received for a period longer than a predetermined duration. That is, even if audio data is interrupted for a period shorter than the predetermined duration, it is treated as part of a continuous statement. However, if audio data is not received for a period longer than the predetermined duration, the next audio data received is treated as audio data based on a new statement, and this point is defined as the start time for receiving audio data. In the present embodiment, the statements from the start of acceptance of a given audio data segment to the start of acceptance of a next audio data segment correspond to one speech segment of the present disclosure.

In addition, regarding the start time for receiving sign language video, in the present embodiment, it is input by the hearing impaired individual via operation on the terminal device 20 for the hearing impaired individual. Specifically, the start time for accepting sign language video and the start time for accepting input text data are obtained when the “Sign Language Start/End Button B” displayed on the terminal device 20 for the hearing impaired individual is selected by the hearing impaired individual. When the “Sign Language Start/End Button B” is selected by the hearing impaired individual on the terminal device 20 for the hearing impaired individual, the selection information is output from the terminal device 20 for the hearing impaired individual to the conversation assisting apparatus 10. The time information obtaining unit 13 detects the point in time when it received the above selection information and sets this as the start time for accepting the sign language video. Furthermore, the time when the “Sign Language Start/End Button B” is selected again after the start time for receiving sign language video is set as the end time for the sign language video. In the present embodiment, the sign language statement from the start time to the end time for receiving the sign language video corresponds to one speech segment of the present disclosure.

Note that the start time of sign language video reception is not limited to that obtained by the method described above. For example, the second text data receiving unit 12 may detect the start time of sign language video reception as a point in time when it detects the start of a sign language action from a captured image, or as a point in time when it detects a video of a predetermined sign language (a specific pose or hand movement, for example). Alternatively, the start/end of sign language gestures may be received via keyboard operation by a hearing impaired individual (pressing the space bar or enter key, for example), with the second text data receiving unit 12 obtaining the point in time when such a keyboard operation occurred.

In addition, regarding the start time for receiving input text data, in the present embodiment, it is obtained by detecting a point in time at which text input is started by the hearing impaired individual on the terminal device 20 for the hearing impaired individual. In the present embodiment, a statement from a start time to an end time of receiving input text data corresponds to one speech segment of the present disclosure. The end time of input text data is obtained, for example, by detecting the pressing of the enter key after text input.

Note that while the time information for the start of conversation by the hearing individual is obtained as the time information for the start of receiving audio data of the hearing individual, the present disclosure is not limited to such a configuration. The time information for the start of receiving the first text data, which is the text data converted from the above audio data, may also be obtained as the time information for the start of conversation by the hearing individual.

In addition, while the time information for the start of communication by the hearing impaired individual is obtained as the time information when reception of the sign language video begins, the present disclosure is not limited to such a configuration. The time information for the start of communication by the hearing impaired individual may alternatively be obtained as the time information when reception of the second text data, which is the translation of the sign language video, begins.

Based on the time information obtained by the time information obtaining unit 13, the control unit 14 displays the first text data of the statement by the hearing individual converted by the first text data receiving unit 11 and the second text data (translated sign language video text data or input text data) received by the second text data receiving unit 12 in a chronologically ordered arrangement on the terminal device 20 for the hearing impaired individual and the shared terminal device 30.

However, as described above, even if a hearing impaired individual begins sign language, there is a problem that the hearing individual may not notice, or translating the sign language into text data may take time, causing the conversation by the hearing individual to proceed further, making it difficult to display the statement by the hearing individual in chronological order in a timely manner.

The control unit 14 of the present embodiment can display the statement by the hearing impaired individual in chronological order in a timely manner to address the aforementioned problem. The display control method performed thereby will be described in detail later.

The conversation assisting apparatus 10 includes a CPU (Central Processing Unit), a semiconductor memory such as a ROM (Read Only Memory) and a RAM (Random Access Memory), storage such as a hard disk, and a communication I/F (Interface).

The storage of the conversation assisting apparatus 10 has a conversation assisting program according to a first embodiment of the present disclosure installed therein. The functions of the components of the conversation assisting apparatus 10 described above are executed by the CPU launching the conversation assisting program according to the first embodiment.

In the present embodiment, the functions of each part are executed by the CPU that runs the conversation assisting program according to the first embodiment. However, some or all of the functions executed by the first embodiment conversation assisting program may be implemented employing hardware such as an ASIC (Application Specific Integrated Circuit), an FPGA (Field-Programmable Gate Array), or other electronic circuits.

Next, the terminal device 20 for the hearing impaired individual will be described.

As described above, the terminal device 20 for the hearing impaired individual is employed by the hearing impaired individual and may be configured, for example, as a personal computer, but may also be configured as a mobile terminal such as a tablet device or a smartphone.

As illustrated in FIG. 1, the terminal device 20 for the hearing impaired individual is equipped with a control unit 21, a display unit 22, a storage unit 23, an input unit 24, and an imaging unit 25.

The control unit 21 controls the entirety of the terminal device 20 for the hearing impaired individual. Specifically, the control unit 21 executes functions such as displaying text of conversations between hearing individuals and the hearing impaired individual, capturing sign language gestures performed by the hearing impaired individual and outputting sign language video, and accepting text input of statements by the hearing impaired individual and outputting the input text data, by launching the meeting assisting application installed in the storage unit 23.

In addition, the control unit 21 displays images captured by the imaging unit 25, images captured by a shared camera 32 which is connected to the shared terminal device 30, and electronic files opened on the terminal device 20 for the hearing impaired individual and the shared terminal device 30, on the display unit 22.

The display unit 22 displays the first text data of the conversation by the hearing individual and the second text data of the communication by the hearing impaired individual, the captured images from the imaging unit 25 and the shared camera 32, and shared electronic files, as described above.

The storage unit 23 has the aforementioned meeting assisting application installed therein.

The input unit 24 receives various setting inputs from the hearing impaired individual, and particularly receives text input of statements by the hearing impaired individual.

The imaging unit 25 includes a CMOS (Complementary Metal Oxide Semiconductor) camera or a CCD (Charge Coupled Device) camera and imaging optics, and captures the sign language gestures performed by the hearing impaired individual. The sign language video data captured by the imaging unit 25 is stored in the storage unit 23 and then output to the conversation assisting apparatus 10 by the control unit 21.

The meeting assisting application may be installed in the storage unit 23 as in the present embodiment, or it may be an application provided via a web browser.

Next, the shared terminal device 30 will be described.

The shared terminal device 30 is used collectively by the hearing individuals of the meeting. It may be configured, for example, by a personal computer, but may alternatively be configured by mobile terminals such as a tablet terminal or a smartphone.

As illustrated in FIG. 1, the shared terminal device 30 is equipped with a control unit 33, a display unit 34, a storage unit 35, and an input unit 36.

The control unit 33 controls the entirety of the shared terminal device 30. Specifically, the control unit 33 executes functions such as displaying text of conversations between hearing individuals and hearing impaired individuals, displaying images captured by the shared camera 32, and handling audio input/output via the shared microphone/speaker 31 by launching a meeting assisting application installed in the storage unit 35.

In addition, the control unit 33 causes the display unit 34 to display sign language images of the hearing impaired individual captured by the imaging unit 25 of the terminal device 20 for the hearing impaired individual, and electronic files which are opened on the terminal device 20 for the hearing impaired individual and the shared terminal device 30.

The display unit 34 displays the second text data of the conversation between the hearing individuals and the hearing impaired individual, the sign language images of the hearing impaired individuals, and shared electronic files, as described above.

The storage unit 35 has the meeting assisting application installed therein, as described above.

The input unit 36 accepts various setting inputs from the hearing individual.

The meeting assisting application may be installed in the storage unit 35 as in the present embodiment, or it may be an application provided via a web browser.

A shared monitor 37 is connected to the shared terminal device 30, and displays the same content as that which is displayed on the display unit 34 of the shared terminal device 30. In addition, the shared microphone/speaker 31 is connected to the shared terminal device 30, and receives audible speech input of conversation by the hearing individuals.

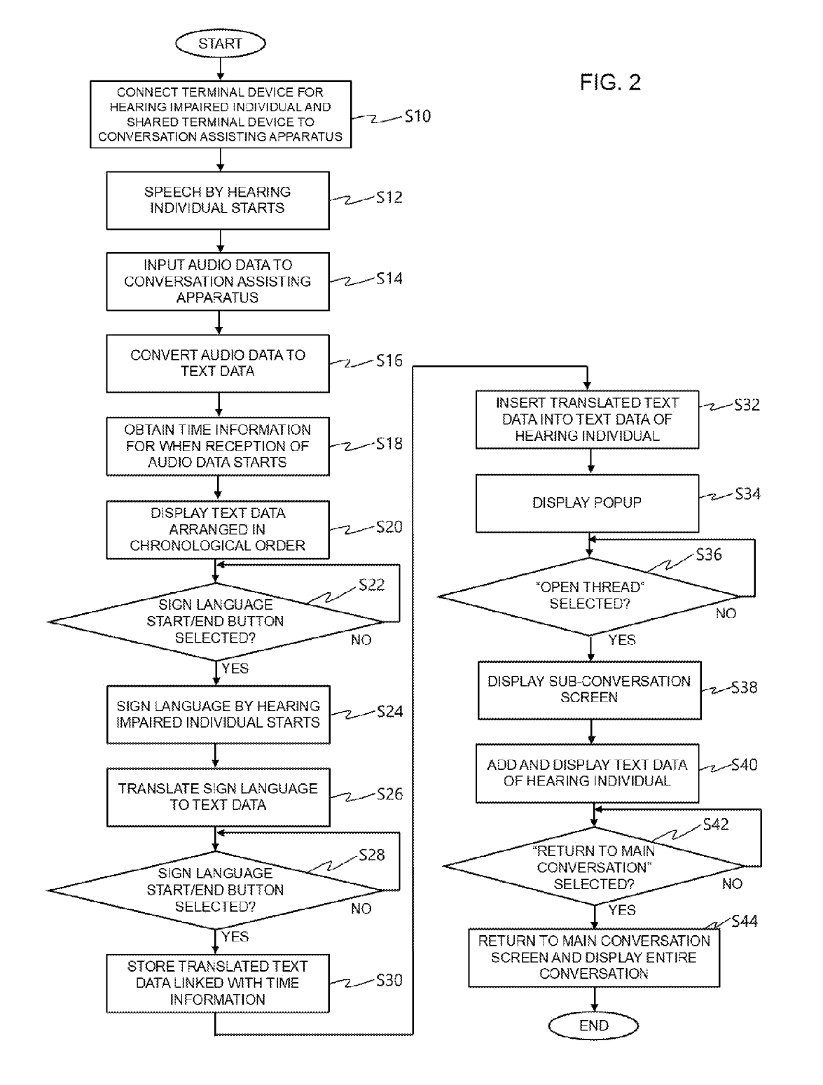

Next, the flow of processes which are performed by the meeting assisting system 1 of the present embodiment will be described with reference to the flowchart illustrated in FIG. 2.

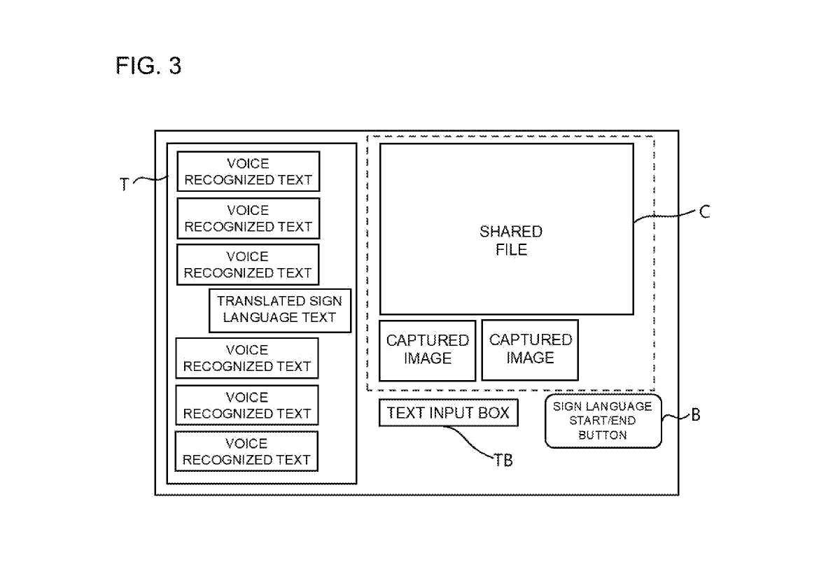

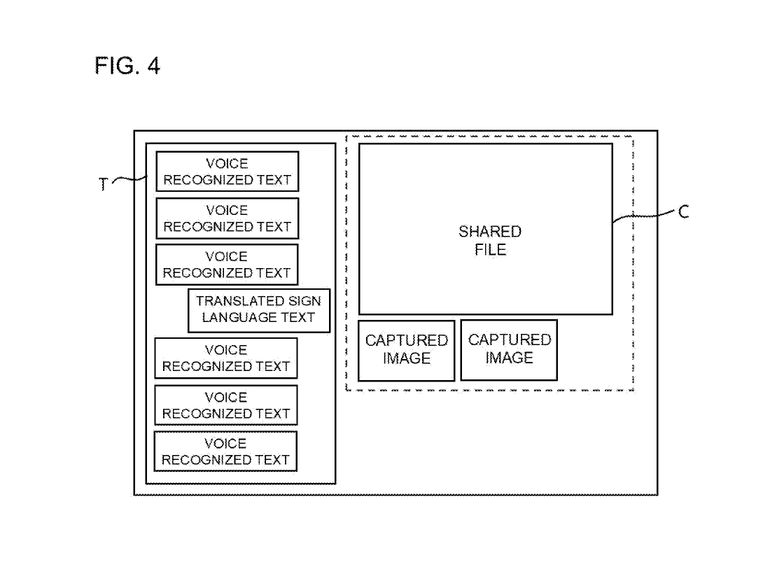

First, the meeting assisting application is launched on both the terminal device 20 for the hearing impaired individual and the shared terminal device 30, and a connection is established with the conversation assisting apparatus 10, which is a cloud server (S10). Then, the meeting assisting application displays a meeting screen for the hearing impaired individual on the terminal device 20 for the hearing impaired individual as illustrated in FIG. 3, and displays a meeting screen on the shared terminal device 30 as illustrated in FIG. 4.

The meeting screen for the hearing impaired individual which is displayed on the terminal device 20 for the hearing impaired individual includes a text display frame T on the left side thereof. The meeting screen for the hearing impaired individual includes a shared screen frame C, a text input box TB, and a sign language start/end button B on the right side thereof. The shared screen frame C displays images of the hearing impaired individual captured by the terminal device 20 for the hearing impaired individual, images of the meeting room captured by the shared camera 32, and electronic files opened on either the terminal device 20 for the hearing impaired individual or the shared terminal device 30.

The meeting screen is the same as the meeting screen for the hearing impaired individual except for the text input box TB and sign language start/end button B not being included therein.

When a hearing individual begins speaking (S12), their speech is input into the shared microphone/speaker 31. The audio data is then output from the shared terminal device 30 and input into the conversation assisting apparatus 10 (S14).

When input of the audio data is received, the conversation assisting apparatus 10 converts it into the first text data via the first text data receiving unit 11 (S16), while the time information obtaining unit 13 obtains the time information at the start of receiving the audio data (S18).

Then, the control unit 14 links the converted first text data with the time information at the start of the reception of the audio data and outputs it to the terminal device 20 for the hearing impaired individual and the shared terminal device 30. The terminal device 20 for the hearing impaired individual and the shared terminal device 30 display the first text data in chronological order within the text display frame T based on the time information linked to the first text data (S20).

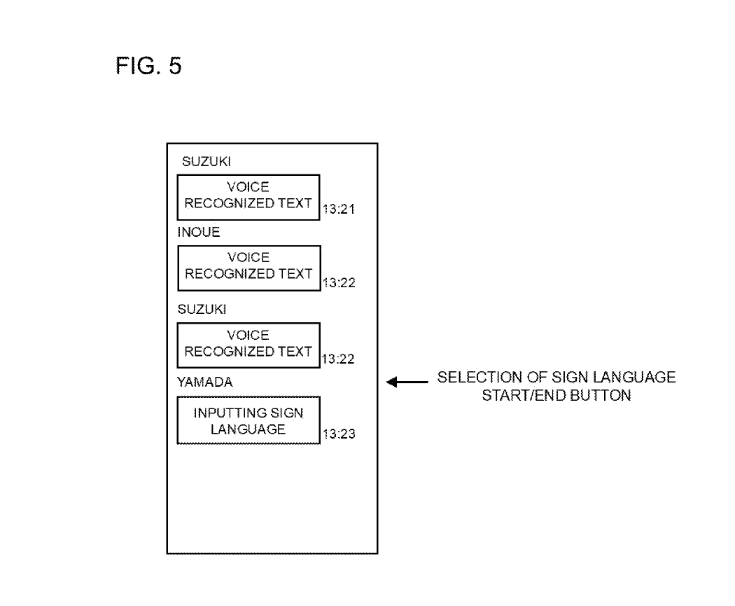

FIG. 5 illustrates an example of a display within the text display frame T of the terminal device 20 for the hearing impaired individual and a display within the shared terminal device 30. In the example illustrated in FIG. 5, the statements of the hearing individuals “Suzuki” and “Inoue” are displayed as text, with time information appended to each statement. In the case that the shared microphone/speaker 31 has a speaker recognition function, the name of the person who spoke is also appended and displayed.

When the hearing impaired individual does not understand the statements by the hearing individuals, has a question, or an opinion regarding the statements by the hearing individuals, and wishes to confirm, ask a question, or express an opinion, they select the sign language start/end button B displayed on the terminal device 20 for the hearing impaired individual. The control unit 14 of the conversation assisting apparatus 10 monitors the selection of the sign language start/end button B on the terminal device 20 for the hearing impaired individual (S22, NO). When the sign language start/end button B is selected (S22, YES), it displays “Sign Language Input in Progress” as illustrated in FIG. 5. In addition, the time information obtaining unit 13 detects that the sign language start/end button B has been selected and obtains the time information at that point in time. In the present embodiment, the selection of the sign language start/end button B corresponds to the predetermined operation input of the present disclosure.

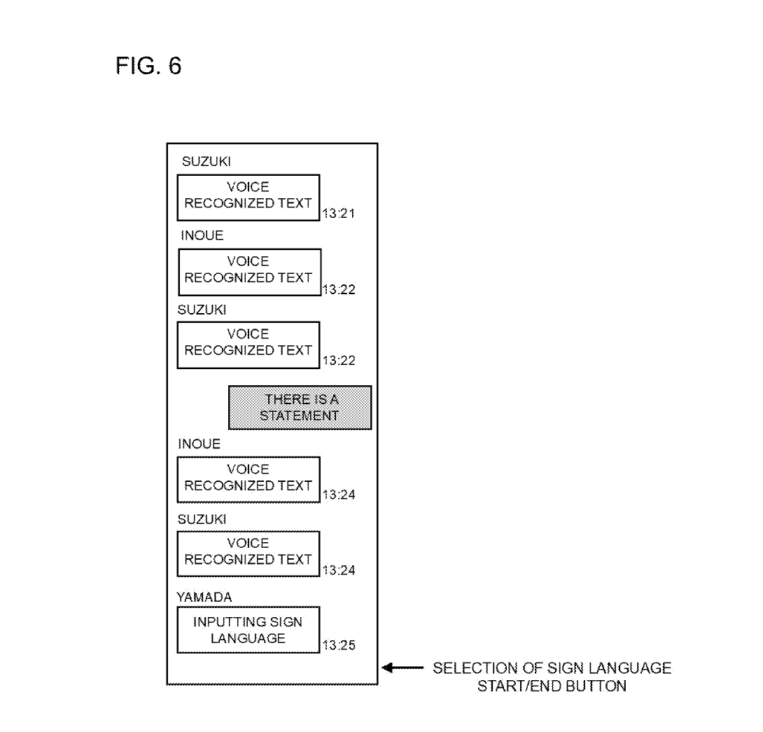

Then, after selecting the sign language start/end button B, the hearing impaired individual begins performing sign language gestures (S24). While the hearing impaired individual is performing sign language gestures, the conversation by the hearing individual continues, and statements by the hearing individuals are displayed in chronological order as illustrated in FIG. 6. However, to indicate the timing of the statement by the hearing impaired individual performing sign language gestures, the control unit 14 displays “There is a statement” as illustrated in FIG. 6, based on the time information at the point in time that the sign language start/end button B was selected. The “There is a statement” display is shown aligned chronologically with the speech by the hearing individual. Additionally, when the hearing impaired individual selects the sign language start/end button B, it may be configured to output a mechanical audible sound from the shared microphone/speaker 31 along with the display of the message “There is a statement”.

When a hearing impaired individual begins performing sign language gestures, the sign language video captured by the terminal device 20 for the hearing impaired individual is output from the terminal device 20 for the hearing impaired individual to the conversation assisting apparatus 10. When the sign language video is input to the conversation assisting apparatus 10, it is translated into text data by the second text data receiving unit 12 and received as the second text data (S26). When the hearing impaired individual completes performing the sign language gestures, they select the sign language start/end button B displayed on the terminal device 20 for the hearing impaired individual again.

When the sign language start/end button B is selected again (S28, YES), the conversation assisting apparatus 10 stores the second text data translated by the second text data receiving unit 12, linked with the time information obtained when the sign language start/end button B was selected at the start of the sign language gestures in S22 (S30).

Then, the control unit 14 of the conversation assisting apparatus 10 compares the time information linked to the first text data of the statement by the hearing individual with the time information linked to the second text data, and inserts the second text data between the first text data of statements by the plurality of hearing individuals such that they are arranged in chronological order (S32).

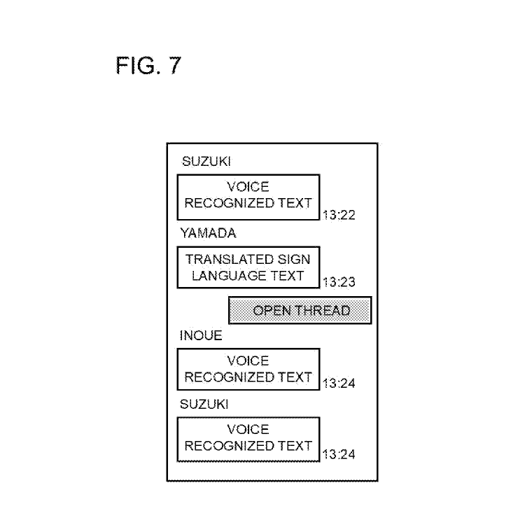

Next, the control unit 14 performs a pop-up display as illustrated in FIG. 7, separate from the main conversation screen illustrated in FIG. 6, on the terminal device 20 for the hearing impaired individual and the shared terminal device 30, in response to the selection of the sign language start/end button B when the sign language gestures are completed (S34).

The control unit 14 displays the aforementioned second text data and also displays the first text data of the statements by the hearing individuals linked to the time information before and after the time information of the second text data within the pop-up display. In addition, as illustrated in FIG. 7, the control unit 14 displays an “Open Thread” button near the display of the second text data within the pop-up display screen.

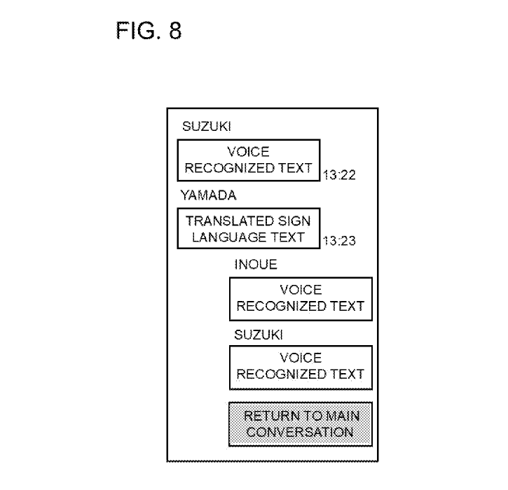

When the “Open Thread” button is selected within the pop-up display screen of the shared terminal device 30 (S36, YES), a sub-conversation screen illustrated in FIG. 8 is displayed on the terminal device 20 for the hearing impaired individual and the shared terminal device 30, separate from the main conversation screen illustrated in FIG. 6 and the pop-up display illustrated in FIG. 7 (S38). The sub-conversation screen displays text similar to the pop-up display. Additionally, the first text data that represents a response by the hearing individual to the second text data of the hearing impaired individual is sequentially added and displayed immediately after the second text data in chronological order (S40). Furthermore, a “Return to Main Conversation” button is displayed at the bottom of the sub-conversation screen.

When the conversation regarding the statement by the hearing impaired individual ends, the “Return to Main Conversation” button is selected on the shared terminal device 30 (S42, YES), returning to the main conversation screen. At this point, the main conversation screen displays the entire conversation, including the content exchanged within the sub-conversation screen, as text (S44).

Note that in the description above, the hearing impaired individual was shown communicating their statements employing sign language. However, as mentioned earlier, they may also communicate by entering text into the text input box TB. In this case, the input text data is displayed as the second text data, replacing the sign language video translation text data described earlier.

Furthermore, in the above description, the time information obtaining unit 13 obtains the time information at the start of sign language reception when the selection of the start/end button B is detected. As an alternative method, the time information obtaining unit 13 may receive a selection by the hearing impaired individual of a specific first text data item from the first text data displayed on the terminal device 20 for the hearing impaired individual that represents a statement by a hearing individual for which the hearing impaired individual wishes to express an opinion or ask a question. Upon detecting this selection, the time information obtaining unit 13 may then obtain the start time for receiving either sign language video or input text data.

In this case, the time information for the start of reception of the sign language video or input text data is obtained as a point in time that immediately follows (e.g., 1 second after) the time information of the statement by the hearing individual selected by the hearing impaired individual. Furthermore, when the second text data is displayed together with the first text data of the statement by the hearing individual, the second text data is displayed immediately after the first text data of the statement by the hearing individual selected by the hearing impaired individual.

According to the meeting assisting system 1 of the embodiment described above, the first text data of conversation by the hearing individual is displayed in chronological order in predetermined speech segments. When communication by the hearing impaired individual begins during the conversation by the hearing individual, the second text data of the communication by the hearing impaired individual is displayed sequentially within the first text data of the conversation by the hearing individual, starting from the point after the reception of the second text data of the communication by the hearing impaired individual is completed. This enables confirmation of the connection between the conversations by the hearing impaired individual and the hearing individuals, facilitates smooth communication, and enables appropriate progression of the conversation.

In addition, in the meeting assisting system 1 described above, the second text data which is received during the conversation by the hearing individual and the first text data of the statement by the hearing individual occurring temporally before or after the start of reception of the second text data are extracted and displayed in the pop-up display. This enables easy confirmation of which statement by the hearing individual the statement by the hearing impaired individual is in response to.

Further, the system is configured to additionally display the first text data of the statement by the hearing individual received after the pop-up display in the sub-conversation screen. This enables smoother conversation in response to the statement by the hearing impaired individual.

Still further, in the meeting assisting system 1 of the embodiment described above, after the sub-conversation screen is displayed, the system returns to the main conversation screen. The system displays the entire conversation in chronological order by inserting the second text data that represents the statement by the hearing impaired individual into the first text data that represent statements by the hearing individual in chronological order. This enables the overall flow of conversation in the meeting to be easily understood.

Still yet further, in the meeting assisting system 1 of the embodiment described above, when the selection of the sign language start/end button by the hearing impaired individual is detected, the system obtains the time information at the start of sign language video reception. This enables the obtainment of the time information at the start of communication by the hearing impaired individual via a simple operation and processing.

In addition, in the meeting assisting system 1 of the embodiment described above, when the start of text input by a hearing impaired individual is detected, the system obtains the time information at the start of receiving the input text data. This enables the time information at the start of the statement by the hearing impaired individual to be obtained via a simple operation and processing.

Further, in the meeting assisting system 1 of the embodiment described above, when the start of sign language gestures by a hearing impaired individual is detected or when a predetermined sign language video is detected, in the case that the system is configured to obtain the start time of sign language video reception, the start time information for communication by the hearing impaired individual can be obtained automatically.

Still further, in the meeting assisting system 1 of the embodiment described above, in the case that the system is configured to accept a selection by the hearing impaired individual of a statement by the hearing individual and to acquire the time information immediately following the time information of the first text data of the selected statement as the start time information of the communication by the hearing impaired individual, the hearing impaired individual can make statements such as questions regarding any statement by the hearing individual, and these can be displayed as text in chronological order.

Next, a meeting assisting system 2 that employs a conversation assisting apparatus according to a second embodiment of the present disclosure will be described in detail.

In the case that a meeting is conducted with two or more hearing individuals and a hearing impaired individual as described above, the statements by the hearing individuals are displayed as text by converting audio data to text. However, when the statements by the hearing individuals continue and their speaking speed is fast, the number of characters in the displayed text can become great. This may exceed the capacity of the hearing impaired individual to understand the information, potentially causing them to lose track of the meeting.

Hearing individuals can simultaneously use three functions: obtaining information through their ears and eyes, and communicating through spoken words. A hearing impaired individual, however, must rely almost entirely on their eyes for both obtaining and communicating information. This results in a significantly larger volume of information to be processed by the hearing impaired individual compared to the hearing individuals. Hearing impaired individuals also often find speaking difficult. In such cases, they must use input devices like keyboards to communicate, requiring them to focus on the input process. During this time, they may struggle to process other incoming information. When the obtainment of information becomes difficult in this manner, the hearing impaired individuals will not be able to follow conversations by the hearing individuals and may lose opportunities to make statements. Conversely, the hearing individuals may perceive silence as a lack of opinion. In addition, when focused on speaking, the hearing individuals may fail to notice that they are conveying so much information that the hearing impaired individual cannot keep up with the meeting.

The meeting assisting system 2 of the second embodiment is capable of issuing an alert when the amount of information being conveyed by hearing individuals is excessive, thereby reducing the burden on a hearing impaired individual and enabling the conversation to proceed appropriately.

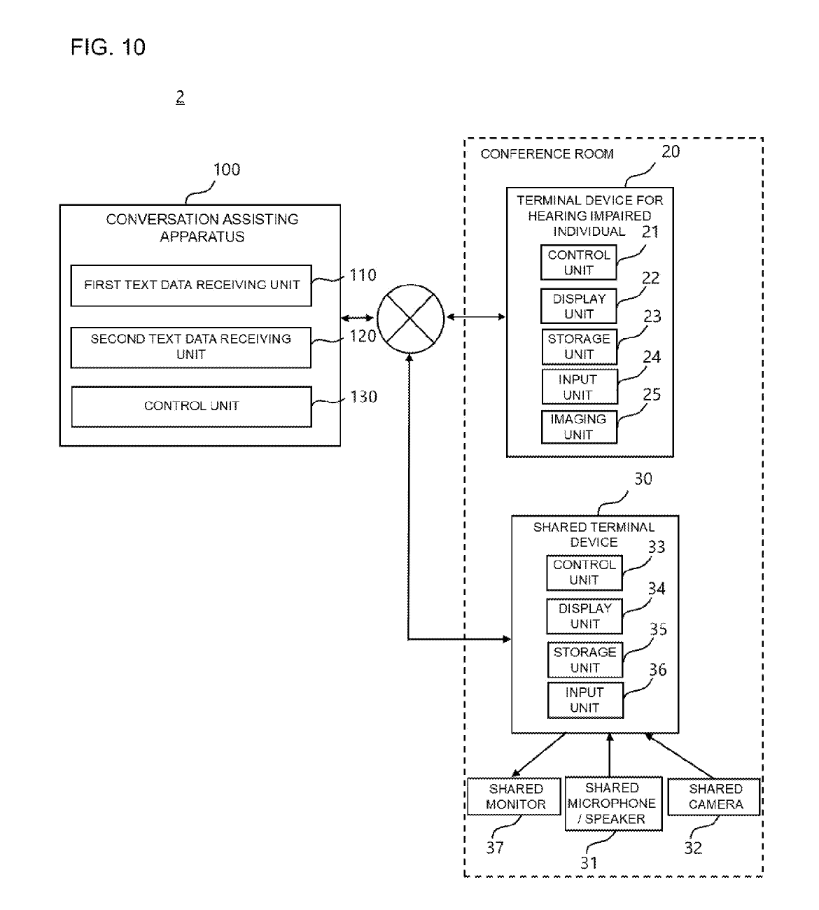

FIG. 10 is a block diagram that illustrates the schematic configuration of the meeting assisting system 2 according to the present embodiment. The following description focuses on points that differ from the meeting assisting system 1 of the first embodiment.

As illustrated in FIG. 10, the meeting assisting system 2 of the present embodiment is also equipped with a conversation assisting apparatus 100, a terminal device 20 for the hearing impaired individual, and a shared terminal device 30.

As illustrated in FIG. 10, the conversation assisting apparatus 100 according to the second embodiment is equipped with a first text data receiving unit 110, a second text data receiving unit 120, and a control unit 130.

The first text data receiving unit 110, similar to the first text data receiving unit 11 of the first embodiment, receives audio data of conversation by the hearing individuals input from the shared microphone/speaker 31 which is connected to the shared terminal device 30 and converts the audio data into text data.

In addition, in the case that the first text data receiving unit 110 has started and continues to receive the audio data, it presumes that speech by the hearing individual is ongoing. It designates a point in time at which audio data ceases to be received for a period longer than a predetermined duration as the end point of the speech by the hearing individual. In the second embodiment, the first text data receiving unit 110 designates the first text data from the start of audio data reception until the point in time at which audio data reception ceases for a period longer than a predetermined duration as a single speech segment. It then outputs the first text data to the control unit 130 in speech segments.

The second text data receiving unit 120, similar to the second text data receiving unit 12 of the first embodiment, receives sign language video input from the camera function of the terminal device 20 for the hearing impaired individual. It translates the input sign language video into text data and receives it as second text data. In addition, the second text data receiving unit 120 is also capable of receiving text data input by the hearing impaired individual employing the terminal device 20 for the hearing impaired individual as the second text data.

In the present embodiment, when a hearing impaired individual wishes to communicate, the “Sign Language Start/End Button B” displayed on the terminal device 20 for the hearing impaired individual is selected.

When the “Sign Language Start/End Button B” is selected on the terminal device 20 for the hearing impaired individual, the selection information is output from the terminal device 20 for the hearing impaired individual to the conversation assisting apparatus 100. The second text data receiving unit 120 begins translating the sign language gestures from the point in time that it receives the aforementioned selection information.

Then, when the hearing impaired individual completes the sign language gestures for their statement, they select the “Sign Language Start/End Button B” again on the terminal device 20 for the hearing impaired individual. When the “Sign Language Start/End Button B” is selected again on the terminal device 20 for the hearing impaired individual, that selection information is output from the terminal device 20 for the hearing impaired individual to the conversation assisting apparatus 100.

Upon receiving the second selection information for the “Sign Language Start/End Button B”, the second text data receiving unit 120 designates the statement by the hearing impaired individual as being completed. It then designates the second text data translated from the receipt of the first selection information for the “Sign Language Start/End Button B” to the receipt of the second selection information for the “Sign Language Start/End Button B” as a single speech segment. It then outputs the second text data of the speech segment to the control unit 130.

Note that the detection of the start and end points for receiving the sign language video is not limited to the selection of the “Sign Language Start/End Button B” described above. For example, the second text data receiving unit 120 may detect the start and end points of sign language gestures from captured images, or detect videos of predefined sign language (such as specific poses or hand movements), and use these points as the start and end points for receiving the sign language video.

In addition, the start/end of sign language gestures may be received based on keyboard operations by the hearing impaired individual (pressing the space bar or enter key, for example), and the second text data receiving unit 120 may also use the point in time when the keyboard operation occurred as the start and end points of the hearing impaired individual’s sign language gestures.

In addition, regarding text data input by the hearing impaired individual employing the terminal device 20 for the hearing impaired individual, in the present embodiment, the text data input from a point in time at which reception of the text data starts to a point of time at which reception of the input text data ends is treated as one speech segment. The point in time at which the reception of the input text data ends is a point in time at which pressing of the Enter key is detected after text input, for example.

Further, the time information for the start and end points of receiving the input text data may be detected by employing an eye-tracking function to detect the time during which the gaze of the hearing impaired individual is on the text input box TB of the meeting screen for the hearing impaired individual to be described later.

The control unit 130 displays the first text data output from the first text data receiving unit 110 and the second text data (translated sign language video text data or input text data) output from the second text data receiving unit 120 in chronological order on the terminal device 20 for the hearing impaired individual and the shared terminal device 30.

Specifically, the control unit 130 displays the first text data and second text data in the speech segments in chronological order as they are received.

Here, as described above, in the case that a series of statements by hearing individuals in a meeting continues, and furthermore, when the hearing individuals speak at a fast pace, for example, the number of characters in the displayed first text data becomes great. This can exceed the capacity of the hearing impaired individual to understand the information, potentially causing them to lose track of the meeting.

Therefore, the control unit 130 of the present embodiment displays an alert on the shared terminal device 30 in the case that the number of characters in the first text data received within a predetermined period exceeds a predetermined threshold. This prompts the hearing individual to stop speaking or slow down their speaking speed. The alert display process will be described in detail later.

The conversation assisting apparatus 100 includes a CPU (Central Processing Unit), a semiconductor memory such as a ROM (Read Only Memory) and a RAM (Random Access Memory), a storage such as a hard disk, and a communication I/F (Interface).

The storage of the conversation assisting apparatus 100 has a conversation assisting program according to the second embodiment of the present disclosure installed therein. The functions of the components of the conversation assisting apparatus 100 described above are executed by the CPU launching the conversation assisting program of the second embodiment.

In the present embodiment, the functions of each component are executed by the CPU running the conversation assisting program of the second embodiment. However, some or all of the functions executed by the conversation assisting program of the second embodiment may be implemented employing hardware such as an ASIC (Application Specific Integrated Circuit), an FPGA (Field-Programmable Gate Array), or other electrical circuits.

The terminal device 20 for the hearing impaired individual has the same configuration as that of the terminal device 20 for the hearing impaired individual of the first embodiment, and has a conversation assisting application installed therein.

In addition, the shared terminal device 30 of the second embodiment also has a configuration similar to that of the shared terminal device 30 of the first embodiment. However, the control unit 33 of the shared terminal device 30 of the second embodiment displays an alert in the case that the character count of the first text data based on the statement by the hearing individual becomes large.

A shared monitor 37 is connected to the shared terminal device 30, and displays the same content as that shown on the display unit 34 of the shared terminal device 30. In addition, a shared microphone/speaker 31 is connected to the shared terminal device 30, and receives audio input of conversation by the hearing individuals.

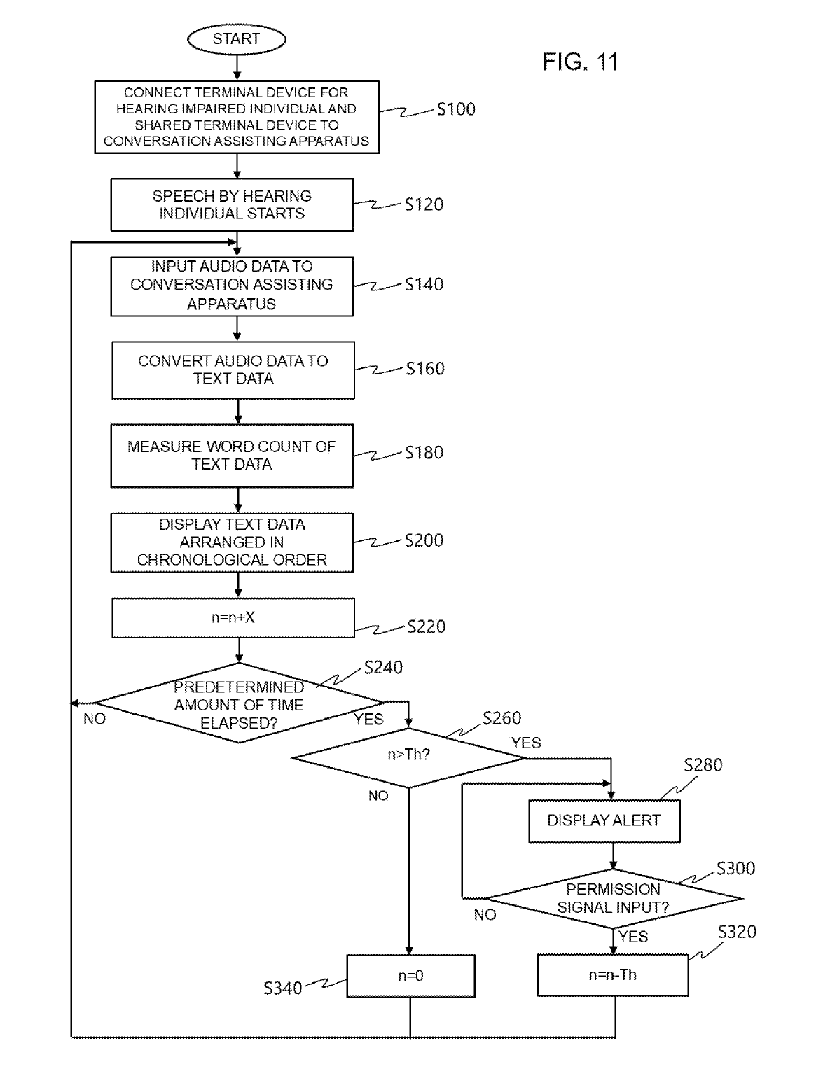

Next, the flow of processes performed by the meeting assisting system 2 of the present embodiment will be described with reference to the flowchart illustrated in FIG. 11. Here, the description will focus on the process that issues an alert to the hearing individuals when the speech of the hearing individuals continues and the speaking speed of the hearing individuals is fast, as described above.

First, the meeting assisting application is launched on both the terminal device 20 for the hearing impaired individual and the shared terminal device 30, connecting them to the conversation assisting apparatus 100, which is a cloud server (S100). Then, the meeting assisting application displays a meeting screen for the hearing impaired individual on the terminal device 20 for the hearing impaired individual as illustrated in FIG. 3, and displays a meeting screen on the shared terminal device 30 as illustrated in FIG. 4.

The meeting screen for the hearing impaired individual which is displayed on the terminal device 20 for the hearing impaired individual includes a text display frame T on the left side thereof. The meeting screen for the hearing impaired individual includes a shared screen frame C, a text input box TB, and a sign language start/end button B on the right side thereof. The shared screen frame C displays images of the hearing impaired individual captured by the terminal device 20 for the hearing impaired individual, images of a conference room captured by the shared camera 32, and shared files opened on either the terminal device 20 for the hearing impaired individual or the shared terminal device 30.

The meeting screen of the shared terminal device 30 is the same as the hearing impaired individual meeting screen, except for the text input box TB and the sign language start/end button B not being included therein.

When a hearing individual begins speaking (S120), their speech is input into the shared microphone/speaker 31. The resulting audio data is output from the shared terminal device 30 and input into the conversation assisting apparatus 100 (S140).

When the audio data is input to the conversation assisting apparatus 100, it is converted into first text data by the first text data receiving unit 110 (S160).

Then, the control unit 130 receives the first text data output from the first text data receiving unit 110 and counts the number of characters X in the received first text data (S180).

In addition, the control unit 130 outputs the first text data to the terminal device 20 for the hearing impaired individual and the shared terminal device 30. The terminal device 20 for the hearing impaired individual and the shared terminal device 30 then display the first text data, arranged in chronological order by speech segment, within the text display frame T (S200).

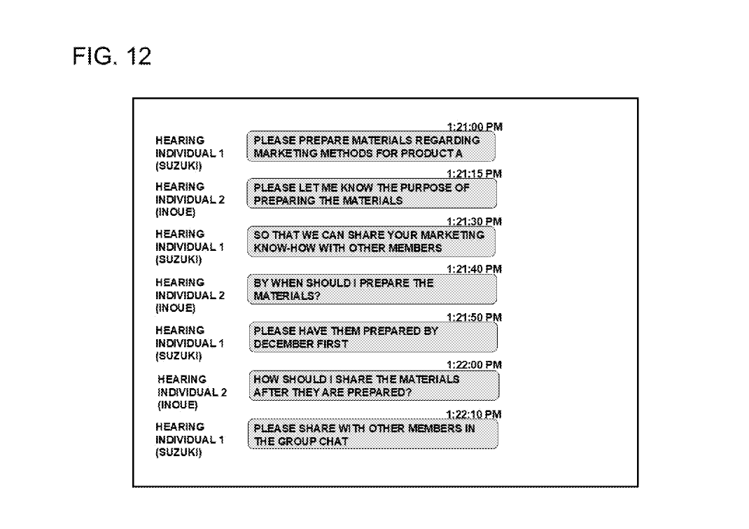

FIG. 12 illustrates an example of the display within the text display frame T of the terminal device 20 for the hearing impaired individual and the shared terminal device 30. In the example illustrated in FIG. 12, the statements of hearing individual 1 (Suzuki) and hearing individual 2 (Inoue) are displayed as text, with time information added to each statement. In the case that the shared microphone/speaker 31 has a speaker recognition function, the name of the person who spoke is also appended and displayed.

Then, the control unit 130 adds the character count X measured in S180 to a character count n (S220). Note that the character count n is set to an initial value of n=0 before the speech by the hearing individual begins.

Next, the control unit 130 checks whether a predetermined period has elapsed since the start of receiving the first text data (S240). The predetermined period is set, for example, to 10 seconds, but is not limited to this and may be set appropriately according to factors such as the ability to read text by the hearing impaired individual.

In the case that the predetermined period has not elapsed since the start of receiving the first text data (S240, NO), the processing steps from S140 to S220 are repeated. On the other hand, if the predetermined period has elapsed since the start of receiving the first text data (S240, YES), the control unit 130 checks whether the character count n exceeds a predetermined threshold Th (S260).

In the case that the character count n exceeds the predetermined threshold Th (S260, YES), the control unit 130 outputs a control signal to the shared terminal device 30 to display an alert. The shared terminal device 30, in response to the control signal output from the control unit 130, displays an alert within the meeting screen displayed on the display unit 34 (S280). The alert may be display of a message such as “Please speak more slowly”.

The control unit 130 continues to display the alert until a permission signal, indicating permission to resume speaking, is input by the hearing impaired individual employing the terminal device 20 for the hearing impaired individual (S300, NO). If the hearing impaired individual reads all of the first text data of the statements by the previous speaker and inputs the permission signal to resume speaking on the terminal device 20 for the hearing impaired individual (S300, YES), the control unit 130 stops display of the alert. Then, the control unit 130 subtracts the number of characters equal to the threshold Th from the character count n (S320), and repeats the processing steps from S140.

In the case that the character count n is less than or equal to a predetermined threshold Th in S260 (S260, NO), the control unit 130 initializes the character count n to zero (S340) and repeats the processing steps from step S140.

In the embodiment described above, the character count is measured for the first text data of the speech by the hearing individual. However, in the terminal device 20 for the hearing impaired individual and the shared terminal device 30, when materials such as shared files are displayed, the character count n may also be calculated by adding the number of characters contained within the displayed materials. The number of characters within the displayed materials may be measured, for example, by recognizing characters employing an OCR (Optical Character Recognition) function. Furthermore, if the displayed material changes within a predetermined period, the number of characters contained in the material after the change is also added. Additionally, if a predetermined period has elapsed since the material was displayed, it may be assumed the hearing impaired individual has already finished viewing it, and the number of characters in the displayed material may not be added (measured).

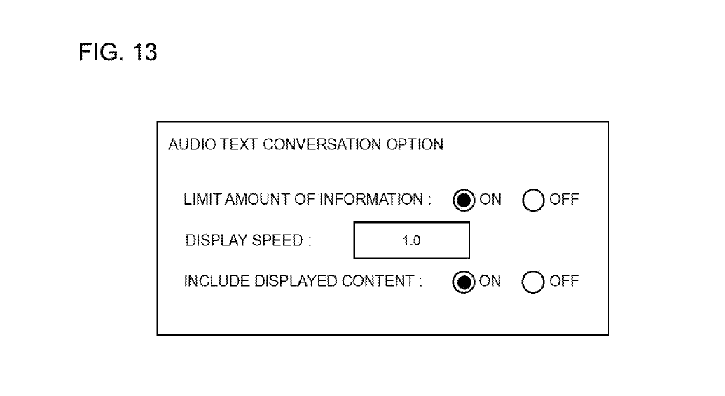

In addition, it may be possible to select whether or not to issue an alert to the hearing individual, as in the embodiment described above. Specifically, the meeting assisting application may display a speech-to-text conversion option screen, such as that illustrated in FIG. 13, on the terminal device 20 for the hearing impaired individual or the shared terminal device 30. If the “ON” radio button for “Information Amount Control” is selected, an alert may be issued; if the “OFF” radio button is selected, an alert may not be issued.

Note that, the speech-to-text conversion option screen illustrated in FIG. 13 also displays radio buttons for selecting the display speed of the first text data and whether to include the number of characters within the other displayed materials. Specifying the display speed allows the display speed of the first text data to be changed. Furthermore, selecting the “ON” radio button for “Include Displayed Materials” enables the character count n to be calculated by including the number of characters contained within the displayed materials. Selecting the “OFF” radio button for “Include Displayed Materials” enables the number of characters contained within the displayed materials to be excluded from the character count n.

In the second embodiment, the threshold Th for triggering the display of an alert may be adjusted, for example, based on whether a single hearing individual is speaking continuously or a plurality of hearing individuals are speaking continuously. Specifically, the threshold Th may be set to 10 seconds when audible speech of only one hearing individual is present in the audio data, and extended to 20 seconds in the case that audible speech of a plurality of hearing individuals is present in the audio data. Known audible voiceprint recognition technology, for example, may be employed to identify the voices of the hearing individuals.

According to the meeting assisting system 2 of the second embodiment, the system receives text data converted from the audio data of the conversation by hearing individuals, displays the text data in chronological order, measures the number of characters in the text data which is received within a predetermined period, and issues an alert in the case that the measured number of characters exceeds a predetermined threshold. This enables a notification that the amount of information being conveyed by the hearing individuals is excessive, thereby reducing the burden on the hearing impaired individual and enabling appropriate progression of the conversation.

In addition, in the meeting assisting system 2 of the second embodiment, the display of the alert continues until the hearing impaired individual inputs a permission signal. This enables the alert to persist until the hearing impaired individual finishes reading the text display of the statement by the hearing individual, enabling a more effective alert for the hearing individual.

Further, in the meeting assisting system 2 of the second embodiment, measuring and adding not only the number of characters included in the first text data but also the number of characters included in the other displayed materials can further reduce the burden on the hearing impaired individual.

Still further, in the case that the meeting assisting system 2 of the second embodiment is configured to accept a selection signal indicating whether to add the number of characters contained in the displayed material, the frequency of alerts can be adjusted according to the preferences of users.

Still yet further, in the case that the meeting assisting system 2 of the second embodiment is configured to accept a selection signal indicating whether to issue an alert, it is also possible to prevent alerts from being issued according to the preferences of users.

Next, a meeting assisting system 3 that employs a conversation assisting apparatus according to a third embodiment of the present disclosure will be described in detail.

In a meeting where two or more hearing individuals are present and a hearing impaired individual joins as described above, for example, discussions may progress through communication among the hearing individuals while the hearing impaired individual is performing sign language gestures or text input.

In such cases, the hearing impaired individual is concentrating on the sign language gestures or the text input, and may find it difficult to monitor the text display of the communication by the hearing individuals and thus will not be able to understand the content thereof.

For example, Japanese Unexamined Patent Publication No. 2019-105741 proposes a meeting minutes tool that converts audio data into text data, summarizes the text data into predetermined segments for display, and enables editing. However, this tool does not address the aforementioned interactive conversation between a hearing impaired individual and hearing individuals.

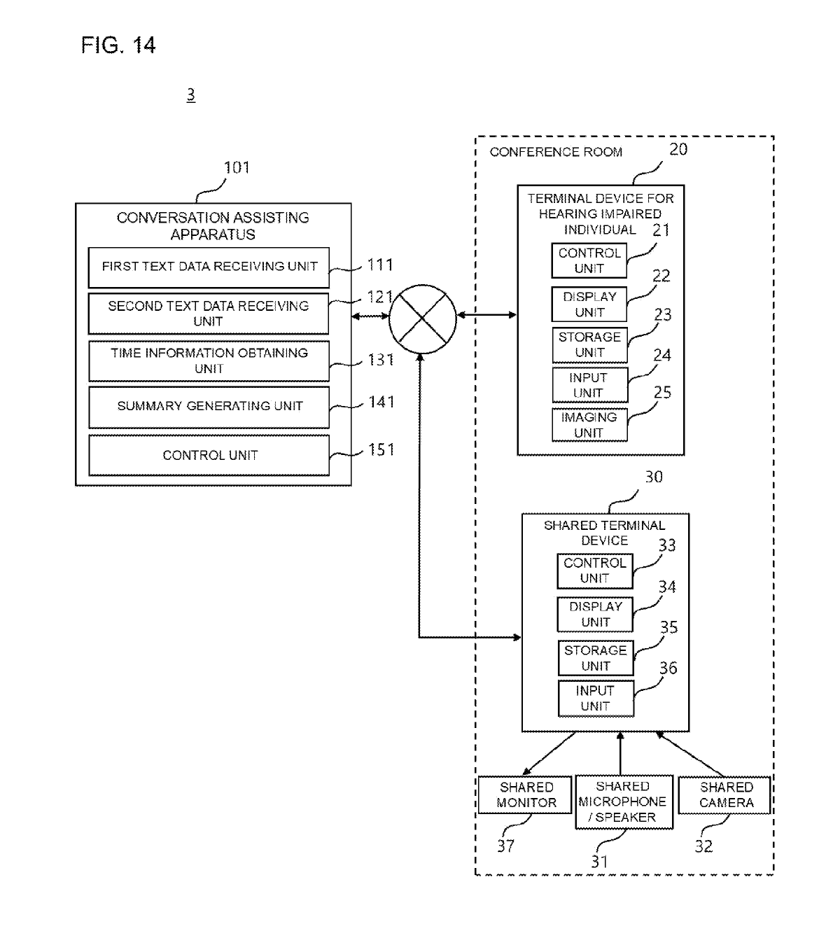

The meeting assisting system 3 of the third embodiment is configured to enable a hearing impaired individual to confirm the content of conversations between hearing individuals that occur during their own statements, thereby facilitating smooth communication and enabling appropriate progression of the conversation. FIG. 14 is a block diagram that illustrates the schematic configuration of the meeting assisting system 3 of the present embodiment.

The meeting assisting system 3 of the present embodiment, like the first and second embodiments, is equipped with a terminal device 20 for the hearing impaired individual, and a shared terminal device 30. The following description focuses on the points that differ from the meeting assisting systems 1 and 2 of the first and second embodiments.

As illustrated in FIG. 14, the conversation assisting apparatus 101 is equipped with a first text data receiving unit 111, a second text data receiving unit 121, a time information obtaining unit 131, a summary generating unit 141, and a control unit 151.

The first text data receiving unit 111 and the second text data receiving unit 121 are the same as those of the first embodiment and the second embodiment. The time information obtaining unit 131 is the same as the time information obtaining unit 13 of the first embodiment.

Here, as described above, while a hearing impaired individual is inputting their own statements via sign language gestures or text input, they are concentrating on such input and thus may find it difficult to confirm the text display of the speech by the hearing individuals.

Therefore, in the present embodiment, the conversation of the hearing individuals during the time that the hearing impaired individual is inputting sign language gestures or text is summarized and presented to the hearing impaired individual.

Specifically, the summary generating unit 141 creates a summary of the first text data received by the first text data receiving unit 111 during the period from the start to the end of the communication by the hearing impaired individual. The summary generating unit 141 creates this summary, for example, by inputting the first text data into an LLM (Large Language Model). Note that the method for generating the summary is not limited to LLM. So called extractive summarization methods that employ statistical methods or graph based methods, etc., may also be employed.

The control unit 151 synchronizes the first text data of the statement by the hearing individual converted by the first text data receiving unit 111 with the second text data (translated sign language video text data or input text data) received by the second text data receiving unit 121 based on the time information obtained by the time information obtaining unit 131, and displays the first text data and the second text data in chronological order on the terminal device 20 for the hearing impaired individual and the shared terminal device 30.

More specifically, the control unit 151 displays the conversation of the hearing individual in chronological order by speech segments, based on the time information at the start of the conversation. In addition, the control unit 151 displays the second text data of communication by the hearing impaired individual at the point when the sign language video or text input ends.

When displaying the communication by the hearing impaired individual, the control unit 151 also displays the summary created by the summary generating unit 141. The method for displaying the summary will be described in detail later.

In addition, when displaying the summary created by the summary generating unit 141 as described above, the control unit 151 generates audio data for the summary, transmits it to the terminal device 20 for the hearing impaired individual and the shared terminal device 30, and outputs it as audio.

The conversation assisting apparatus 101 includes a CPU (Central Processing Unit), a semiconductor memory such as a ROM (Read Only Memory) and a RAM (Random Access Memory), a storage such as a hard disk, and a communication I/F (Interface).

The storage of the conversation assisting apparatus 101 has a conversation assisting program according to the third embodiment of the present disclosure installed therein. The functions of the components of the conversation assisting apparatus 101 described above are executed by the CPU launching the conversation assisting program.

In the present embodiment, the functions of each component are executed by the CPU running the conversation assisting program. However, some or all of the functions executed by the conversation assisting program may be implemented employing hardware such as an ASIC (Application Specific Integrated Circuit), an FPGA (Field-Programmable Gate Array), or other electrical circuits.

The terminal device 20 for the hearing impaired individual of the third embodiment has a configuration similar to that of the terminal device 20 for the hearing impaired individual of the first embodiment and has a conversation assisting application installed therein. However, the control unit 21 of the terminal device 20 for the hearing impaired individual of the third embodiment executes functions such as the text display and audio output of the summary of the conversation by the hearing individuals described above.

In addition, the shared terminal device 30 of the third embodiment also has a configuration similar to that of the shared terminal device 30 of the first embodiment. However, the control unit 33 of the shared terminal device 30 of the third embodiment displays the text of the summary of the conversation by the hearing individuals and transmits the audio data of the summary of the conversation by the hearing individuals to the shared microphone/speaker 31 to output it as audio.

The display unit 34 displays the first text data of the conversation by hearing individuals, the second text data of the communication by the hearing impaired individual, the summary of the conversation by the hearing individuals, the hearing impaired individual’s sign language images, the images captured by the shared camera, and shared electronic files, etc., as described above.

The shared monitor 37 connected to the shared terminal device 30 displays the same content as that displayed on the display unit 34 of the shared terminal device 30. Furthermore, the shared terminal device 30 has the shared microphone/speaker 31 connected thereto, which accepts audio input of the conversation by the hearing individuals and outputs the summary of the conversation by the hearing individuals as audio, as described above. In the present embodiment, the summary of the conversation by the hearing individuals is output as audio from the shared microphone/speaker 31, but it may also be output as audio from the terminal device 20 for the hearing impaired individual.

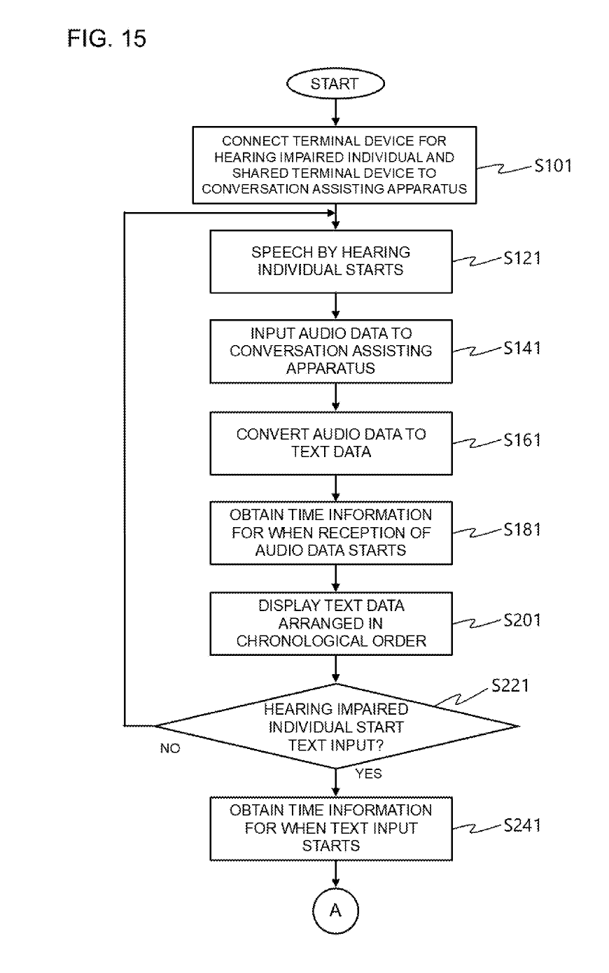

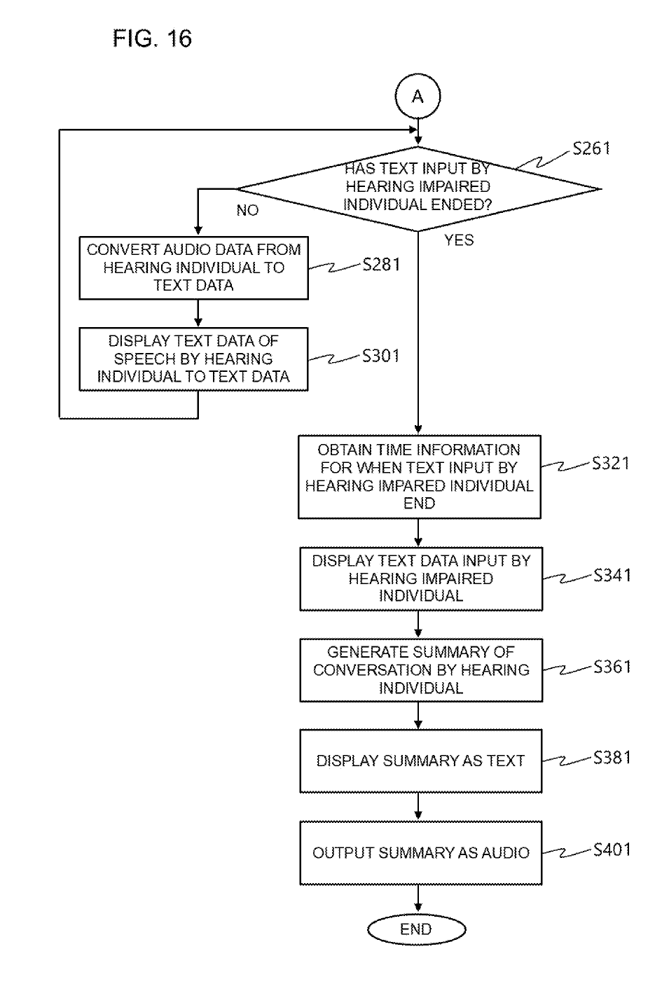

Next, the flow of processes performed by the meeting assisting system 3 of the present embodiment will be explained with reference to the flowcharts illustrated in FIGS. 15 and 16.

First, the meeting assisting application is launched on the terminal device 20 for the hearing impaired individual and the shared terminal device 30, and a connection is established to the conversation assisting apparatus 101, which is a cloud server (S101). Then, the meeting assisting application displays a meeting screen for the hearing impaired individual on the terminal device 20 for the hearing impaired individual as illustrated in FIG. 3, and displays a meeting screen on the shared terminal device 30 as illustrated in FIG. 4.

When a hearing individual begins speaking (S121), their speech is input into the shared microphone/speaker 31. The resulting audio data is then output from the shared terminal device 30 and input into the conversation assisting apparatus 101 (S141).

Upon receiving the audio data, the conversation assisting apparatus 101 converts the audio data into first text data via the first text data receiving unit 111 (S161) and obtains time information for the start of audio data reception via the time information obtaining unit 131 (S181).

The control unit 151 then stores the converted first text data linked with the time information of the start of audio data reception, outputs it to the terminal device 20 for the hearing impaired individual and the shared terminal device 30, and the terminal device 20 for the hearing impaired individual and the shared terminal device 30 display the first text data in chronological order in the text display frame T based on the time information linked to the first text data (S201).

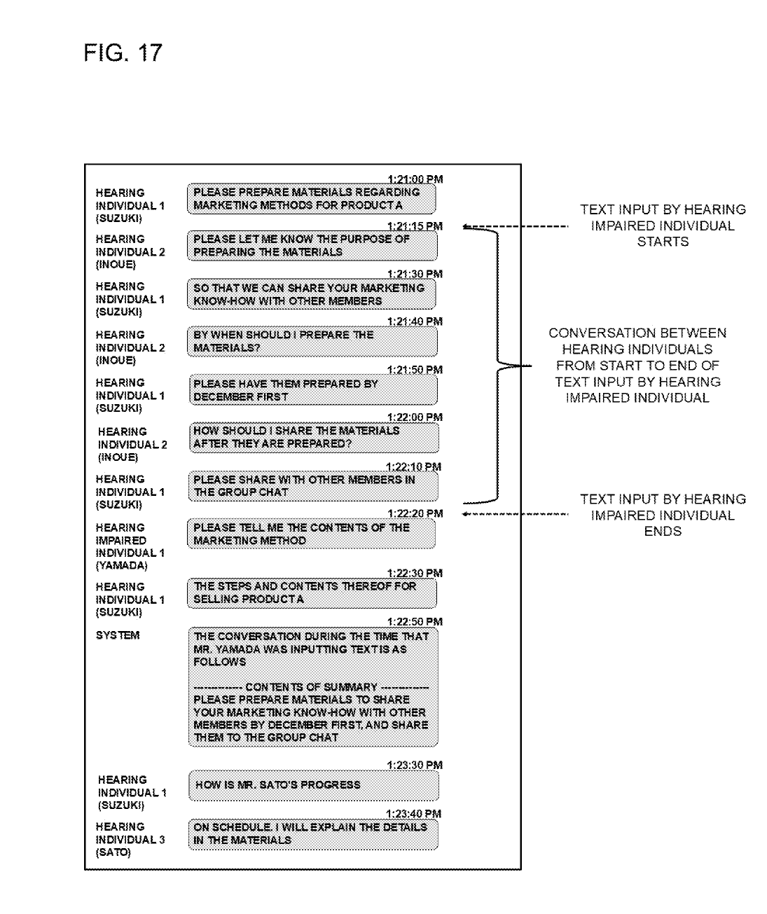

FIG. 17 illustrates an example of the display within the text display frame T of the terminal device 20 for the hearing impaired individual and the shared terminal device 30. In the example illustrated in FIG. 17, the statements of hearing individual 1 (Suzuki) and hearing individual 2 (Inoue) are displayed as text, with time information appended to each statement. If the shared microphone/speaker 31 has a speaker recognition function, the name of the person who spoke is also appended and displayed.

Here, a case in which hearing impaired individual 1 (Yamada) wishes to ask a question regarding a statement by hearing individual 1 (Suzuki) (1:21:00 PM) and begins text input (S221, YES) will be described. The time information obtaining unit 131 of the conversation assisting apparatus 101 obtains and stores the time information (1:21:15 PM) when hearing impaired individual 1 (Yamada) began text input (S241) .

Next, while hearing impaired individual 1 (Yamada) inputs text (1:21:15 PM to 1:22:20 PM) (S261, NO), conversation continues between hearing individual 1 (Suzuki) and hearing individual 2 (Inoue). Conversion from the audio data to the first text data (S281) and display of the first text data (S301) are performed sequentially.

Then, when the end of text input by hearing impaired individual 1 (Yamada) is detected (S261, YES), the time information obtaining unit 131 of the conversation assisting apparatus 101 obtains and stores the time information (1:22:20 PM) at the end of text input by hearing impaired individual 1 (Yamada) (S321).

Next, the control unit 151 displays the second text data input by hearing impaired individual 1 (Yamada) (1:22:20 PM) (S341). At this time, the second text data may also be converted to speech and output via the shared microphone/speaker 31.

Then, hearing individual 1 (Suzuki) answers the question from hearing impaired individual 1 (Yamada), and first text data that represents the answer is displayed (1:22:30 PM). Furthermore, the summary generating unit 141 of the conversation assisting apparatus 101 obtains the first text data of the conversation between hearing individual 1 (Suzuki) and hearing individual 2 (Inoue) from the start time to the end time (1:21:15 PM to 1:22:20 PM) of the text input by hearing impaired individual 1 (Yamada), and creates a summary thereof (S361). Thereafter, the control unit 151 displays the text data of the summary generated by the summary generating unit 141 (1:22:50 PM) (S381), converts the text data of the summary to audio, transmits it to the terminal device 20 for the hearing impaired individual and the shared terminal device 30, and outputs it as audio (S401).

Next, after the audio output reading of the summary ends, a next topic begins with a statement from hearing individual 1 (Suzuki) (1:23:30 PM), which is displayed as text.

In the example illustrated in FIG. 17, the summary text data is displayed after the display of the first text data of the response from hearing individual 1 (Suzuki) (1:22:30 PM). However, the display position of the summary text data is not limited to this. The summary text data may be displayed at any position after the summary text data is generated. For example, if the generation of the summary text data is completed between the display of the second text data input by hearing impaired individual 1 (Yamada) (1:22:20 PM) and the display of the first text data of the response by hearing individual 1 (Suzuki) (1:22:30 PM), it may be displayed at that position.

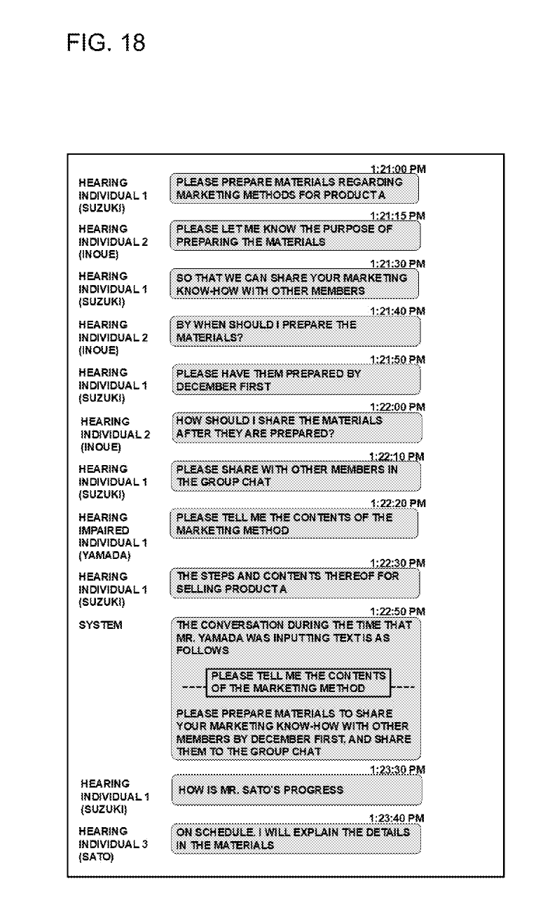

In addition, the summary text data may be displayed in association with the second text data input by hearing impaired individual 1 (Yamada). For example, the second text data input by hearing impaired individual 1 (Yamada) may be displayed within the display area for the summary text data, as illustrated in FIG. 18. Alternatively, the second text data input by hearing impaired individual 1 (Yamada) may be displayed as a speech bubble relative to the display area for the summary text data.

Further, while the above description is of an example in which the conversation by hearing impaired individual 1 (Yamada) is input as text, in the case that the conversation by hearing impaired individual 1 (Yamada) is input via sign language gestures, a summary of the hearing individual’s conversation is generated during the sign language input, and text display and audible speech output are performed.

In the third embodiment described above, the text data that summarizes the conversation of the hearing individual was output as audio. However, whether or not to perform audio output may be selectable by the user. Specifically, the user may input a selection regarding whether to output the text data of the summary of the conversation of the hearing individual as audio at the terminal device 20 for the hearing impaired individual or the shared terminal device 30, for example. The control unit 151 of the conversation assisting apparatus 101 may receive this selection and output the audio data of the summary text data to the terminal device 20 for the hearing impaired individual or the shared terminal device 30 only in the case that the option to output the summary text data as audio is selected.

According to the meeting assisting system 3 of the third embodiment described above, a summary is created for the first text data of the conversation by the hearing individuals received between the start and end points of the communication by the hearing impaired individual. The first text data of the conversation by the hearing individuals and the second text data of the communication by the hearing impaired individual are displayed in chronological order, and the summary text data of the conversation by the hearing individuals is displayed. This enables the hearing impaired individual to confirm the content of conversations between the hearing individuals that occurred during their own speech, facilitating smooth communication and enabling appropriate progression of the conversation.

In addition, in the meeting assisting system 3 of the third embodiment, in the case that the summary of the first text data received from the start to the end of the communication by the hearing impaired individual and the second text data of the communication by the hearing impaired individual are displayed in association, it becomes possible to clearly understand the summary of which conversation by the hearing individuals corresponds to which statement made by the hearing impaired individual.

Further, in the case that the meeting assisting system 3 of the third embodiment is configured to output the summary of the first text data of the conversation by the hearing individuals as audio, the hearing individuals can immediately recognize that a summary is being displayed to the hearing impaired individual. This enables the hearing individuals to wait until the hearing impaired individual finishes reading the text summary before making their next statement.

Still further, in the meeting assisting system 3 of the third embodiment, if the system is configured to receive a selection as to whether to perform audio output of the summary of the first text data of the conversation by the hearing individuals, and audio output of the summary is performed only when this selection is made, users are enabled to choose whether to perform audio output according to their preference.

Still yet further, in the meeting assisting system 3 of the third embodiment, when the start of sign language gestures by the hearing impaired individual is detected or when a predetermined sign language video is detected, the system obtains the time information at the start of the communication by the hearing impaired individual. This enables automatic obtainment of the time information at the start of the statement by the hearing impaired individual.

In addition, in the meeting assisting system 3 of the third embodiment, in the case that the system is configured to obtain the time information of the start point of sign language video reception when the selection of the sign language start/end button B by the hearing impaired individual is detected, the time information of the start point of the communication by the hearing impaired individual can be obtained via a simple operation and processing.

Further, in the meeting assisting system 3 of the third embodiment, in the case that the system is configured to obtain the time information at the start of receiving input text data when the start of text input by the hearing impaired individual is detected, the time information at the start of the communication by the hearing impaired individual can be obtained via a simple operation and processing.

Note that the meeting assisting systems 1 to 3 described above as embodiments described assist conversations between hearing individuals and hearing impaired individuals. Hearing impaired individuals include those with hearing impairments, hearing disabilities, hearing difficulties, hearing loss, or hearing and speech impediments. In addition, a second individual in a conversation who communicates without employing audible speech in the present disclosure is not limited to hearing impaired individuals but also includes hearing individuals who cannot produce sound, such as those in noisy environments or surrounding conditions, and others who require communication employing text.

In addition, the present disclosure is not limited to the embodiments described above and may be embodied by modifying components within a scope that does not deviate from the spirit and scope of the disclosure during implementation. Various aspects of the disclosure may also be formed by appropriately combining a plurality of components disclosed in the embodiments described above. For example, all of the components which are disclosed in the embodiments may be combined as appropriate. It goes without saying that various modifications and applications are possible within a scope that does not deviate from the spirit of the disclosure.

The following additional items are disclosed with respect to the present disclosure.

### Item 1

The conversation assisting apparatus of the present disclosure is a conversation assisting apparatus that assists conversation between a first individual in a conversation who converses employing audible speech and a second individual in the conversation who converses without employing audible speech, and is equipped with: a first text data receiving unit that receives first text data converted from audio data of speech by the first individual; a second text data receiving unit that receives second text data, which is one of text data converted from images capturing sign language gestures performed by the second individual and text data input by the second individual; a time information obtaining unit that obtains time information that indicates a start time of the conversation initiated by speech by one of the first individual and sign language gestures or text data input by the second individual; and a control unit that displays the first text data of speech by the first individual in chronological order in predetermined speech segments according to the time information obtained by the time information obtaining unit, and in the case that sign language gestures or text data input by the second individual begins during speech by the first individual, inserts and displays the second text data into the first text data of the speech by the first individual in chronological order after the receiving of second text data of the second individual has been completed.

### Item 2

In the conversation assisting apparatus according to Item 1, the control unit may extract the second text data received during the speech by the first individual and the first text data which is temporally close to the start point of the communication by the second individual after the reception of the second text data has ended, and perform display in a different manner from the display of the first text data in chronological order.

### Item 3

In the conversation assisting apparatus according to Item 2, the control unit may further display the first text data received after the display in the different manner.

### Item 4

In the conversation assisting apparatus according to Item 3, the control unit may insert the second text data into the first text data in the chronological order of speech by the first individual and display them in chronological order when it receives an input of a predetermined instruction after the display in the different manner.

### Item 5

In the conversation assisting apparatus according to any of Items 1 through 4, the time information obtaining unit may obtain the time information of the start point of the communication by the second individual when the start of sign language gestures by the second individual is detected or when a predetermined sign language video is detected.

### Item 6

In the conversation assisting apparatus according to any of Items 1 through 4, the time information obtaining unit may obtain the time information of the start point of the communication by the second individual when a predetermined operational input by the second individual is detected.

### Item 7

In the conversation assisting apparatus according to any of Items 1 through 6, the time information obtaining unit may obtain the time information of the start point of the communication by the second individual when the start of text input by the second individual is detected.

### Item 8

In the conversation assisting apparatus according to any of Items 1 through 7, the time information obtaining unit may obtain time information immediately following the time information of selected first text data as the time information of the start point of the communication by the second individual when the selection of the first text data of a predetermined statement by the first individual is detected.

### Item 9

The conversation assisting apparatus of the present disclosure is equipped with a text data receiving unit that receives text data obtained by converting audio data of a conversation by an individual in the conversation into text, and a control unit that displays the text data received by the text data receiving unit in chronological order, measures the number of characters in the text data received within a predetermined period, and issues an alert in the case that the measured number of characters exceeds a predetermined threshold.

### Item 10

In the conversation assisting apparatus according to Item 9, the control unit may continue issuing the alert until it receives input of a predetermined permission signal from an individual in a conversation different from the individual of the audio data.

### Item 11

In the conversation assisting apparatus according to Item 9 or 10, the control unit may measure and add the number of characters contained in other display objects when the other display objects are displayed alongside text data.

### Item 12

In the conversation assisting apparatus according to Item 11, the control unit may receive a selection signal indicating whether to add the number of characters included in the other display objects.

### Item 13

In the conversation assisting apparatus according to any of Items 9 through 12, the control unit may receive a selection signal indicating whether to issue the alert.

### Item 14

The conversation assisting apparatus of the present disclosure is a conversation assisting apparatus that assists conversation between a first individual in a conversation who converses employing audible speech and a second individual in a conversation who converses without employing audible speech, and is equipped with a first text data receiving unit that converts audio data of speech by the first individual into text data, a second text data receiving unit that receives one of text data converted from images capturing sign language gestures performed by the second individual and text data input by the second individual as second text data, a time information obtaining unit that obtains time information for the start and end points of a communication by the second individual by sign language gestures or text data input by the second individual, a summary generating unit that generates a summary of the first text data received by the first text data receiving unit during the period from the start to the end of the communication by the second individual obtained by the time information obtaining unit, and a control unit that displays the first text data and the second text data in chronological order and displays the summary generated by the summary generating unit.

### Item 15

In the conversation assisting apparatus according to Item 14, the control unit may display the summary of the first text data received during the period from the start to the end of the communication by the second individual associated with the second text data of the communication by the second individual.

### Item 16

In the conversation assisting apparatus according to Item 14 or 15, the control unit may output the summary of the first text data as audio.

### Item 17

In the conversation assisting apparatus according to Item 16, the control unit may receive a selection of whether to perform audio output of the summary of the first text data, and may perform the audio output of the summary only in the case that the selection is made to perform the audio output of the summary.

### Item 18

In the conversation assisting apparatus according to any of Items 14 through 17, the time information obtaining unit may obtain time information for the start or end point of the communication by the second individual when the start or end of sign language gestures by the second individual is detected, or when a predetermined sign language video is detected.

### Item 19

In the conversation assisting apparatus according to any of Items 14 through 17, the time information obtaining unit may obtain time information for the start or end point of communication by the second individual when a predetermined operational input by the second individual is detected.

### Item 20

In the conversation assisting apparatus according to any of Items 14 through 19, the time information obtaining unit may obtain time information for the start or end point of communication by the second individual when the start or end of text input by the second individual is detected.

### Item 21

A conversation assisting method of the present disclosure is a conversation assisting method that assists conversation between a first individual in a conversation who converses employing audible speech and a second individual in the conversation who converses without employing audible speech, and includes: receiving first text data converted from audio data of speech by the first individual, receiving second text data, which is one of text data converted from images capturing sign language gestures performed by the second individual and text data input by the second individual, obtaining time information that indicates a start of conversation for speech by both the first individual and sign language gestures or text data input by the second individual, displaying the first text data of the speech by the first individual in chronological order in predetermined speech segments according to the obtained time information, and in the case that sign language gestures or text data input by the second individual begins during the speech by the first individual, inserting and displaying the second text data into the first text data of the speech by the first individual in chronological order after the receiving of second text data of the second individual has been completed.

### Item 22

A conversation assisting method of the present disclosure converts audio data of speech by an individual in a conversation into text to receive text data, displays the received text data in chronological order, measures the number of characters in the text data received within a predetermined period, and issues an alert in the case that the measured number of characters exceeds a predetermined threshold.

### Item 23

A conversation assisting method of the present disclosure is a conversation assisting method that assists conversation between a first individual in a conversation who converses employing audible speech and a second individual in the conversation who converses without employing audible speech, and includes converting audio data of speech by the first individual into text data and receiving first text data, receiving one of text data converted from images capturing sign language gestures performed by the second individual and text data input by the second individual as second text data, obtaining time information for the start and end points of a communication by the second individual by sign language gestures or text data input by the second individual, generating a summary of the first text data received during the period from the start to the end of the communication by the second individual, displaying the first text data and the second text data in chronological order, and displaying the summary.

### Item 24

A non-transitory computer-readable recording medium containing a conversation assisting program of the present disclosure is a conversation assisting program that assists conversation between a first individual in a conversation who converses employing audible speech and a second individual in the conversation who converses without employing audible speech, and causes a computer to execute: a step of receiving first text data converted from audio data of speech by the first individual, a step of receiving second text data, which is one of text data converted from images capturing sign language gestures performed by the second individual and text data input by the second individual, a step of obtaining time information that indicates a start of conversation for speech by both the first individual and sign language gestures or text data input by the second individual, a step of displaying the first text data of the speech by the first individual in chronological order in predetermined speech segments according to the obtained time information, and in the case that sign language gestures or text data input by the second individual begins during the speech by the first individual, inserting and displaying the second text data into the first text data of the speech by the first individual in chronological order after the receiving of second text data of the second individual has been completed.

### Item 25

A non-transitory computer-readable recording medium containing a conversation assisting program of the present disclosure causes a computer to execute: a step of converting audio data of speech by an individual in a conversation into text to receive text data, a step of displaying the received text data in chronological order, a step of measuring the number of characters in the text data received within a predetermined period, and a step of issuing an alert in the case that the measured number of characters exceeds a predetermined threshold.

### Item 26

A non-transitory computer-readable recording medium containing a conversation assisting program of the present disclosure is a conversation assisting program that assists conversation between a first individual in a conversation who converses employing audible speech and a second individual in the conversation who converses without employing audible speech, and causes a computer to execute a step of converting audio data of speech by the first individual into text data and receiving first text data, a step of receiving one of text data converted from images capturing sign language gestures performed by the second individual and text data input by the second individual as second text data, a step of obtaining time information for the start and end points of a communication by the second individual by sign language gestures or text data input by the second individual, a step of generating a summary of the first text data received during the period from the start to the end of the communication by the second individual, and a step of displaying the first text data and the second text data in chronological order and displaying the summary.

What is claimed is:

1. A conversation assisting apparatus that assists conversation between a first individual in a conversation who converses employing audible speech and a second individual in the conversation who converses without employing audible speech, comprising:
a first text data receiving unit that receives first text data converted from audio data of speech by the first individual;
a second text data receiving unit that receives second text data, which is one of text data converted from images capturing sign language gestures performed by the second individual and text data input by the second individual;
a time information obtaining unit that obtains time information that indicates a start time of the conversation initiated by speech by one of the first individual and sign language gestures or text data input by the second individual;
a control unit that displays the first text data of the speech by the first individual in chronological order in predetermined speech segments according to the time information obtained by the time information obtaining unit, and in the case that sign language gestures or text data input by the second individual begins during speech by the first individual, inserts and displays the second text data into the first text data of the speech by the first individual in
chronological order after the receiving of second text data of the second individual has been completed.

2. The conversation assisting apparatus according to claim 1, wherein:
the control unit extracts the second text data received during the speech by the first individual and the first text data which is temporally close to the start point of the communication by the second individual after the reception of the second text data has ended;
and performs display in a different manner from the display of the first text data in chronological order.

3. The conversation assisting apparatus according to claim 2, wherein:
the control unit further displays the first text data received after the display in the different manner.

4. The conversation assisting apparatus according to claim 3, wherein:
the control unit inserts the second text data into the first text data in the chronological order of speech by the first individual and displays them in chronological order when it receives an input of a predetermined instruction after the display in the different manner.

5. The conversation assisting apparatus according to claim 1, wherein:
the time information obtaining unit obtains the time information of the start point of the communication by the second individual when the start of sign language gestures by the second individual is detected or when a predetermined sign language video is detected.

6. The conversation assisting apparatus according to claim 1, wherein:
the time information obtaining unit obtains the time information of the start point of the communication by the second individual when a predetermined operational input by the second individual is detected.

7. The conversation assisting apparatus according to claim 1, wherein:
the time information obtaining unit obtains the time information of the start point of the communication by the second individual when the start of text input by the second individual is detected.

8. The conversation assisting apparatus according to claim 1, wherein:
the time information obtaining unit obtains time information immediately following the time information of selected first text data as the time information of the start point of the communication by the second individual when the selection of the first text data of a predetermined statement by the first individual is detected.

9. The conversation assisting apparatus according to claim 1, wherein:
a control unit that measures the number of characters in the first text data received within
a predetermined period, and issues an alert in the case that the measured number of characters exceeds a predetermined threshold.

10. The conversation assisting apparatus according to claim 9, wherein:
the control unit measures and adds the number of characters contained in other display objects when the other display objects are displayed alongside text data.

11. The conversation assisting apparatus according to claim 1, wherein:
a summary generating unit that generates a summary of the first text data received by the first text data receiving unit during the period from the start to the end of the communication by the second individual obtained by the time information obtaining unit; and
a control unit that displays the first text data and the second text data in chronological order and displays the summary generated by the summary generating unit.

12. The conversation assisting apparatus according to claim 11, wherein:
the control unit displays the summary of the first text data received during the period from the start to the end of the communication by the second individual associated with the second text data of the communication by the second individual.

13. The conversation assisting apparatus according to claim 12, wherein:
the control unit outputs the summary of the first text data as audio.

14. The conversation assisting apparatus according to claim 13, wherein:
the control unit receives a selection of whether to perform audio output of the summary of the first text data; and
performs the audio output of the summary only in the case that the selection is made to perform the audio output of the summary.

15. A conversation assisting method that assists conversation between a first individual in a conversation who converses employing audible speech and a second individual in the conversation who converses without employing audible speech, comprising:
receiving first text data converted from audio data of speech by the first individual;
receiving second text data, which is one of text data converted from images capturing sign language gestures performed by the second individual and text data input by the second individual;
obtaining time information that indicates a start of conversation for speech by both the first individual and sign language gestures or text data input by the second individual;
displaying the first text data of the speech by the first individual in chronological order in predetermined speech segments according to the obtained time information; and
in the case that sign language gestures or text data input by the second individual begins during the speech by the first individual, inserting and displaying the second text data into the first text data of the speech by the first individual in chronological order after the receiving of second text data of the second individual has been completed.

16. A non-transitory computer-readable recording medium containing a conversation assisting program that assists conversation between a first individual in a conversation who converses employing audible speech and a second individual in the conversation who converses without employing audible speech, that causes a computer to execute the operations comprising:
receiving first text data converted from audio data of speech by the first individual;
receiving second text data, which is one of text data converted from images capturing sign language gestures performed by the second individual and text data input by the second individual;
obtaining time information that indicates a start of conversation for speech by both the first individual and sign language gestures or text data input by the second individual;
displaying the first text data of the speech by the first individual in chronological order in predetermined speech segments according to the obtained time information; and
in the case that sign language gestures or text data input by the second individual begins during the speech by the first individual, inserting and displaying the second text data into the first text data of the speech by the first individual in chronological order after the receiving of second text data of the second individual has been completed.
